(19) United States
(12) Patent Application Publication
(10) Pub. No.: US 2019/0076219 A1
(43) Pub. Date: Mar. 14, 2019

(54) ORTHODONTIC BRACKET

(71) Applicant: Christoph VON MANDACH, Bözberg (CH)

(72) Inventor: Christoph Von Mandach, Bözberg (CH)

(21) Appl. No.: 16/081,722

(22) PCT Filed: Feb. 21, 2017
(86) PCT No.: PCT/EP2017/053941

§ 371 Date: Aug. 31, 2018

(30) Foreign Application Priority Data
Mar. 1, 2016 (CH) 00264/16

(51) Int. Cl. A61C 7/14; A61C 7/18; A61C 7/28; A61C 7/04

(52) U.S. Cl. CPC A61C 7/141; A61C 7/145; A61C 7/08; A61C 7/28; A61C 7/04; A61C 7/18

(57) ABSTRACT

A particularly simple orthodontic bracket manufactured using cutting and bending technology, proposed for a number of different indications, includes a base plate having an adhesive side and a visible side, and an element for the guided retention of a treatment arch wire. The bracket is made in one piece and has, as a guiding element, a longitudinal guiding bulge extending mesio-distally and shaped out of the plane of the base plate. A treatment arch wire can be guided through beneath the guide bulge, such that it lies against the base plate.

### FIELD OF THE INVENTION

The present invention relates to an orthodontic bracket made of sheet metal manufactured using a cutting and bending technology, comprising a base plate with an adhesive side and a visible side and means for guided retention of a treatment arch wire.

In addition, the invention relates to the use of such a bracket as well as the means required to do so for setting the bracket.

### BACKGROUND OF THE INVENTION

In the early days of orthodontic technology, many orthodontic apparatuses were made of sheet metal by cutting and punching technology and attached to bands secured around a tooth. Such an approach is disclosed in U.S. Pat. No. 1,142,790, for example, which was filed by Mr. E. H. Angle in 1915. Mr. Angle was one of the actual founders of orthodontic technology. Additional examples of such brackets manufactured by cutting and bending technology are known from U.S. Pat. Nos. 2,686,365, 2,257,069, 3,076,265 as well as a self-alloying bracket known from U.S. Pat. No. 3,218,713, for example. One of the simplest and most logical versions of such a bracket is disclosed in U.S. Pat. No. 2,265,420. The bracket which is manufactured by cutting and bending technology shown here is in one piece, having an adhesive side and a visible side and is equipped with means for guided retention of a treatment arch wire. This bracket is of course also soldered directly to a band and is not attached directly to the tooth by adhesive. The approach shown here has two lateral fastening straps, by means of which the bracket is soldered to a band, and then two hairpin-shaped flanges connected to one another by means of a groove bottom are then connected to one another via a groove bottom. The approximately U-shaped channel thereby formed tapers toward the open side, so that the treatment arch wire can be inserted and clamped between the two lateral flanges. The resulting channel is approximately U-shaped and tapers toward the open side, so that the treatment arch wire can be inserted and clamped between the two lateral flanges. The treatment arch wire could not actually be secured in this U-shaped channel, and the treatment arch wire could be pressed out of the U-shaped channel by food residues. Securing the bracket by means of ligatures was impossible with this bracket.

Due to advances in miniaturization and new manufacturing techniques as well as the possibility, which is also new, of gluing the brackets directly to the tooth, there has been an incremental progression away from brackets manufactured by the cutting and bending technique, and brackets were next manufactured from metal, initially by cutting methods and later by means of powder injection molding in the so-called MIM technology, where MIM stands for metal injection molding. One example of such a bracket, which had already been manufactured in part from solid metal and shows only a cover connected to the bracket, so that it has the mobility of a hinge, is disclosed in U.S. Pat. No. 3,091,857, for example. U.S. Pat. No. 3,543,404 was filed in 1969, wherein the bracket consists essentially of a base plate manufactured by a punching and bending technology and having loops, which served to releasably attach a ligature strap. The ligature strap made of wire would press the treatment arch wire against the visible side of the base plate.

The cutting and bending technology has been further developed to a great extent in the last 50 years, further miniaturization now being possible with more complex shapes. The present applicant has taken up this technology again. A self-alloying bracket having a pivotable plate, manufactured by cutting and bending technology, is disclosed in WO 2015/140026, wherein both parts of the orthodontic bracket, namely the plate and the base plate, can be connected to one another by pivoting them toward one another. In accordance with the miniaturization that can be achieved with this self-alloying bracket, it can be used both lingually and buccally for treating most deformities and defects that occur involving teeth.

However, there is a need for a particularly simple and small orthodontic bracket that can be used for a limited indication but is also particularly easy to use. Such a greatly simplified orthodontic bracket of the type defined in the introduction should be suitable for the following indications in particular:
for use of dental arch segments of up to eight teeth with basically simple malpositioning,
for highly pronounced malpositioning of individual teeth with an otherwise more or less harmonic dental arch;
for support and simplification of treatment with rails (such as INVISALINE® (a registered trademark of the company Align Technology, Inc.));
for lingual treatment of mild front tooth corrections, wherein the last wire needed for correction can also be left in place for long-term retention;
as a single element for correction of simple to severely dystrophic teeth.

Accordingly, one aspect of the present invention relates to a particularly simple method of manufacturing orthodontic brackets by a cutting and bending technology, said bracket being suitable for the aforementioned indications.

In an embodiment, the bracket is manufactured in one piece and has at least one elongated guide arch shaped out of the plane of the base plate, and the treatment arch is guided to rest on the base plate beneath said guide arch.

Additional embodiments of the invention are also disclosed and are described on the basis of the following description with reference to the accompanying drawings.

The invention also relates to use of the orthodontic bracket according to the invention and also discloses means according to the invention for installing the claimed orthodontic bracket. The unit of the invention with respect to the orthodontic brackets according to the invention and the claimed means for installing these brackets is derived from the obligatory shape adjustment of the means to one another according to the lock-and-key principle. These means cannot be used for other orthodontic brackets.

### BRIEF DESCRIPTION OF THE DRAWINGS

The drawings illustrate various embodiments of the subject matter of the invention and are described in detail below, wherein:

FIG. 1 shows a perspective view of the orthodontic bracket with a view to the visible side, and

FIG. 2 shows the same view of the adhesive side;

FIG. 3 shows the same bracket in a horizontal section, and

FIG. 4 shows a side section;

FIG. 5 shows a variant of the bracket according to FIGS. 1 through 4 but with two guide arches arranged in a line in a perspective diagram with a view of the visible side, and

FIG. 6 shows the same with a view of the adhesive side;

FIG. 7 shows a third variant of the orthodontic bracket according to the invention in a perspective view with a view of the visible side, while

FIG. 8 shows the same bracket in a view from above, and

FIG. 9 shows the same in a side view, while

FIG. 10 shows this bracket in a side view with a view of the longitudinal side;

FIG. 11 shows a fourth embodiment of the bracket according to the invention, again in a perspective view, and

FIG. 12 shows the same bracket in a view from above, and

FIG. 13 shows it in a side view;

FIGS. 14 and 15 show a protector with a retaining rod and handle in a perspective view, and

FIG. 16 shows this protector with a view of the front side of the retaining rod with an attached orthodontic bracket according to FIG. 9;

FIGS. 17 and 18 show a two-part protector while the bracket is being attached as well as pliers or a plier-type gripper capable of gripping the two protector halves with the attached bracket.

### DETAILED DESCRIPTION OF THE INVENTION

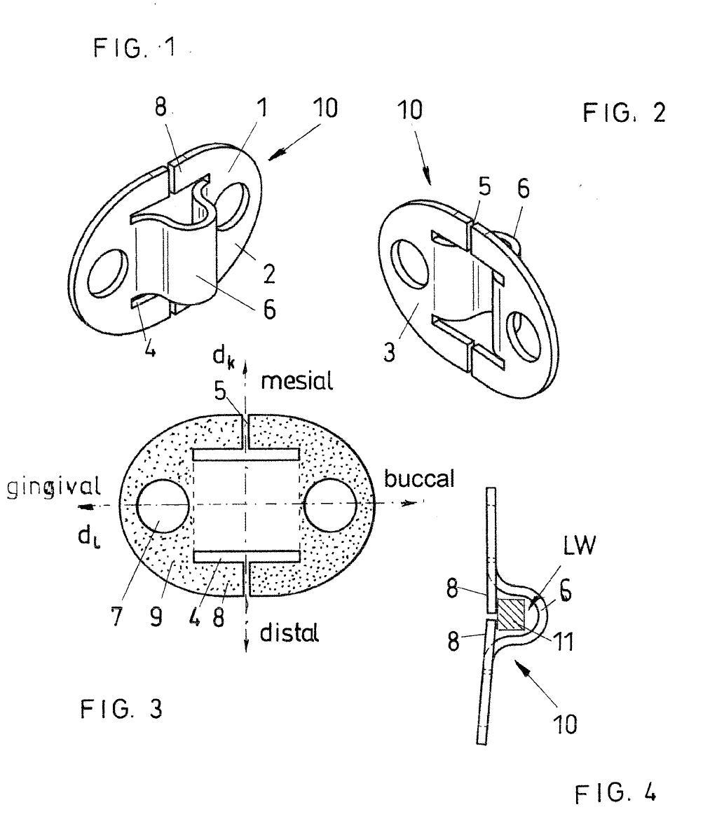

In the following description, the directional information is given according to orthodontic terminology, which is applicable to the orthodontic brackets attached to the respective teeth. FIGS. 1 through 4 show a first embodiment of the orthodontic bracket according to the invention. It consists of an essentially planar base plate 1. The base plate has a visible side 2 and an adhesive side 3. The visible side is the side facing away from the tooth, while the adhesive side is the side facing the tooth. Since this orthodontic bracket can be used in both lingual and buccal positions, the terms lingual and buccal will not be used to identify the two sides. In a buccal application the visible side is on the buccal side while the adhesive side or adhesive face is on the lingual side, whereas these terms are exactly reversed for a lingual side. The base plate 1 here is essentially oval in shape. The longitudinal axis di shown here runs in a buccal-gingival orientation. However, the short axis dk runs in a mesial-distal orientation. Two slot-shaped punched-out areas 4 run parallel to the longitudinal axis di and parallel to one another.

One punched-out area runs in the mesial-distal direction centrally and perpendicular to the slot-shaped punched-out areas 4 from each side edge on the short axis dk up to the slot-shaped punched-out areas 4. These short punched-out areas are labeled as 5. An elongated guide arch 6 is present between the two slot-shaped punched-out areas 4 running in the gingival-buccal direction. This guide arch also runs in the mesial-distal direction. The guide arch 6 is of such dimensions in width and height that a treatment arch 11 finds a guided receptacle therein and rests laterally on the guide arch 6 on plates 8 of the base plate 1.

In manufacturing the orthodontic bracket 10, the base plate 1 is punched out while completely flat, with the short punched-out area 5 being significantly wider than in the finished state, as illustrated in FIGS. 1-4. The bending operation, in which the guide arch 6 is formed, is performed only after this punching, wherein the base plate at the same time is pushed together in the direction of the longitudinal axis, until the short punched-out areas 5 have been pushed together except for a small gap. The guide arch 6 is shaped here so that four plates 8 are formed by the punched-out areas 4 and 5 at the side of the guide arch 6.

In punching, a grid-shaped structure can be formed on the adhesive side 3, but this is logically limited to the area sitting directly on the tooth during use. This area is characterized as a structured area 9 with a dotted line in FIG. 3. The structuring in the area 9 serves to increase the adhesion of the adhesive on the orthodontic bracket 1. Additional apertures 7 may optionally be shaped in the structured adhesive area 9. These apertures 7 serve, on the one hand, to facilitate the bracket halves being pushed together in the direction of movement of the longitudinal axis, and they have the additional benefit that light of a polymerization lamp can be supplied better for curing an adhesive.

FIG. 4 illustrates a treatment arch 11, which is held resting on the lateral plates 8 of the base plate 1 beneath the guide arch 6. In the example illustrated here, the treatment arch 11 is illustrated with a square cross section. However, a treatment arch having a round, polygonal or even oval cross section can also be introduced through this guide arch 6.

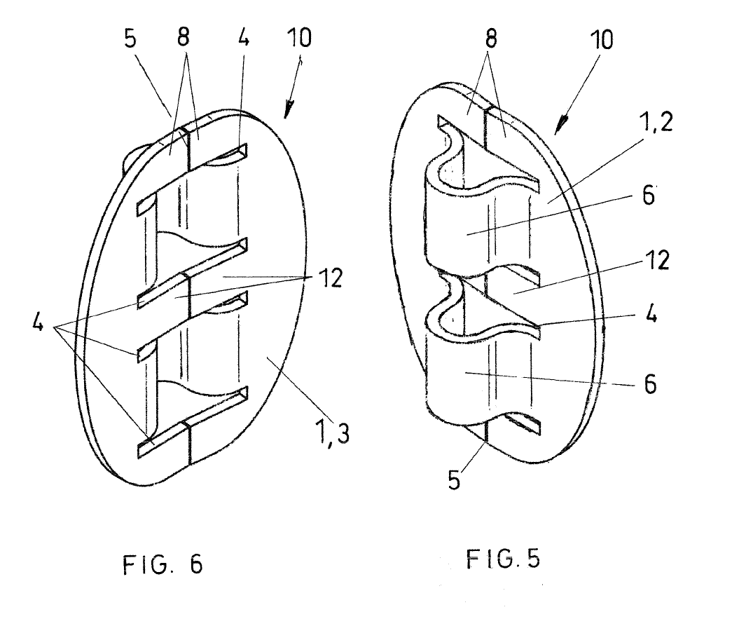

One variation of the orthodontic bracket 10 is illustrated in FIGS. 5 and 6, where two guide arches 6 parallel to one another are provided, thus forming a longer guide for the treatment arch 11 in the bracket. Accordingly, there are four parallel slot-shaped punched-out areas here and two central plates 12 also remain here between the two neighboring guide arches 6 in addition to the lateral plates 8. The two guide arches 6 are aligned, so that they are exactly flush with one another and again run in the mesial-distal direction. The orthodontic bracket 10 is therefore somewhat larger and is suitable accordingly to be applied to the molars or to the upper front teeth. However, these brackets can also be applied easily to other teeth depending on the patient's situation.

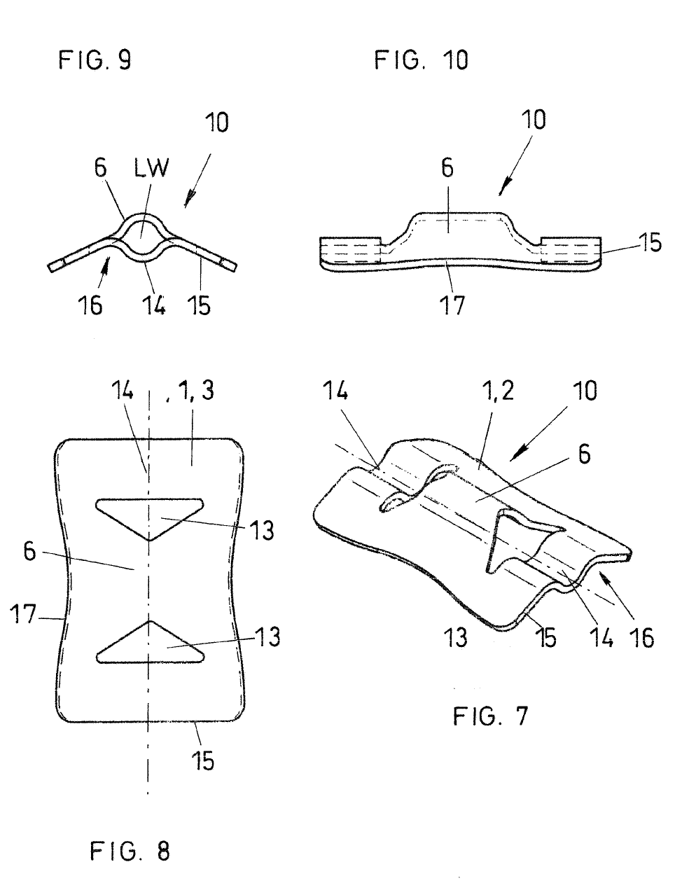

Another embodiment of the orthodontic bracket is shown in FIGS. 7 to 10. In this embodiment, the base plate 1 has an essentially rectangular cross section with rounded corners. Essentially triangular window-shaped punched-out areas 13 are formed in the base plate 1. The triangular window-shaped punched-out areas 13 have rounded corners to prevent the corresponding notch effects. A guide arch 6 that curves upward toward the visible side 2 is in turn formed between the two window-shaped punched-out areas 13. Here again, the guide arch 6 of course runs in a mesial-distal direction. Only shorter mesial and/or distal side edges 15 run from the window-shaped punched-out areas 13 toward guide channels 14 that are curved downward toward the adhesive side. At the side of the guide channels, the base plate again runs with a slight increase toward the adhesive side. Therefore receiving spaces 16 to receive the adhesive are formed beneath the orthodontic bracket on the adhesive side 2. In this embodiment, no apertures 7 are necessary because the window-shaped punched-out areas 13 form a sufficient opening to supply light to the adhesive side. Light can also be supplied through the elevations, which are formed to the side of the guide channels 14 and create the above-mentioned spaces 16 for receiving adhesive. With this embodiment of the orthodontic bracket 10, the length of the guide arch is shortened by the triangular window-shaped punched-out areas 13, but a treatment arch is guided not only in the area of the guide arch 6 but also in the area of the guide channels 14 due to the guide channels 14 following at the side.

It should be pointed out, only for the sake of a better understanding, that the central constriction, which can be seen in the longitudinal edges 17, is formed only with the guide arch 6, which is created by a bending technique. Such a constriction is not necessary for reasons of space, because this constriction runs only in a gingival-buccal direction, and there are not usually any space problems in this direction.

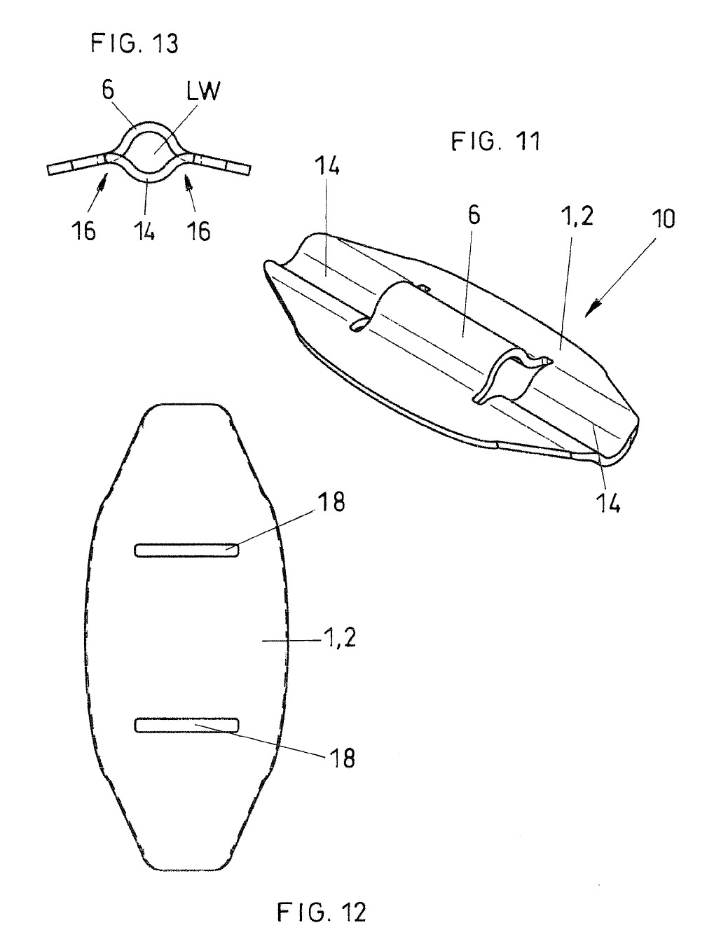

Finally, FIGS. 11-13 show a fourth embodiment of the orthodontic bracket 10 according to the invention. The base plate 1 is approximately in the shape of a boat in the outline and instead of the window-shaped punched-out areas 13, there are two parallel punched-out areas 18, which are in the shape of buttonholes and are shaped a relatively great distance apart from one another here. These punched-out areas 18 run in the buccal-gingival direction. In the lateral outline according to FIG. 13, one can again see the lateral guide channels 14 as well as the adhesive spaces 16. Although this embodiment variant is quite logical in an orthodontic sense, this variant is less preferred because it is more difficult to insert the treatment arch beneath the guide arch 6 in this variant in comparison with the version with the window-shaped punched-out areas 13. The triangular window-shaped punched-out areas 13 cause the apparatus to be centered during insertion of the treatment arch, whereas the end face of the guide arch 6 in the embodiment according to FIGS. 11-13 does not create this centering, and therefore necessitates a very accurate alignment of the treatment arch, so that the treatment arch does not abut against the side face of the arch 6 at the end.

Orthodontic brackets are usually accurately adapted to the dimensions and shape of a treatment arch. This necessitates a relatively large number of different brackets, depending on the cross-sectional shape and diameter of the treatment arches used. The orthodontic brackets according to the invention do not require such an accurate correspondence of orthodontic bracket and treatment arch. In contrast with a bracket made of metal by cutting or centering and having a corresponding slot that cannot be altered, the guide arch is deformed slightly by means of pliers in the case of the orthodontic bracket according to the invention, in order to thereby reduce the pass-through opening here or to also exert a slightly increased pressure on the treatment arch. This use according to the invention cannot be achieved today with any bracket available on the market without requiring a flap or ligatures. This technique or this use also makes it possible to use a treatment arch with practically any cross-sectional shape. If the inside clearance of the pass-through beneath the guide arch 6 is larger than the cross section of the treatment arch, then a notch can also be impressed into the guide arch 6, so that the inside clearance beneath the guide arch is thereby reduced.

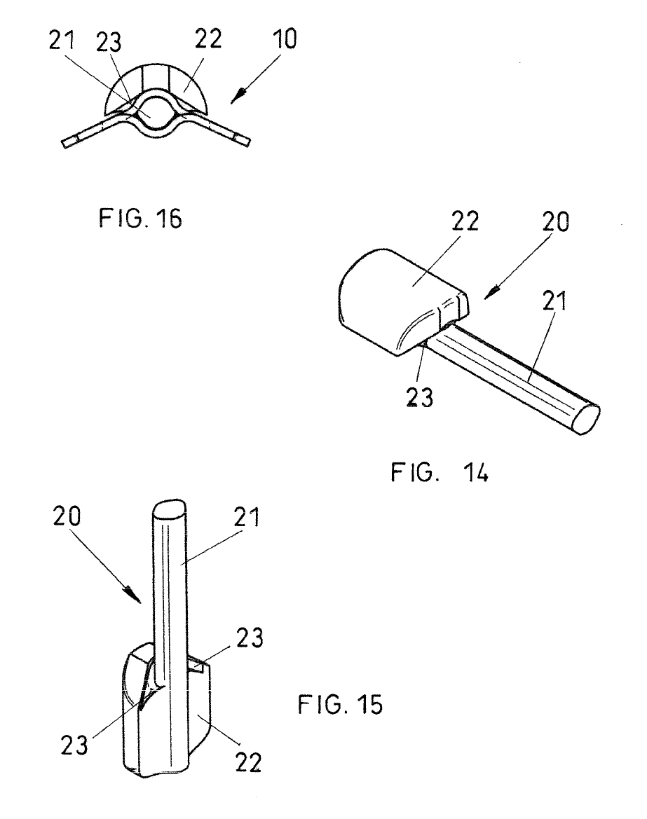

With the brackets known today, there are no passages in the base plate that would allow the adhesive that is applied to penetrate into the area of the slot. This risk also exists with the brackets according to the invention. Accordingly, special protectors must be offered for these brackets, to prevent adhesive from penetrating into the guide area for the treatment arch. FIGS. 14 through 16 illustrate one such means having a particularly simple design in the form of a protector. This protector 20 consists essentially of a retaining rod 21, which corresponds in cross section at least approximately to the inside clearance LW of the orthodontic bracket 10. The inside clearance is formed by the parts of the bracket, with which the treatment arch is in contact or on which they rest. In the embodiments according to FIGS. 1 through 6, these are the lateral plates 8 and optionally the central plates 12, on the one hand, and the guide arch 6 or guide arches 6, on the other hand. In principle, it is sufficient if the protector 20 consists of only one retaining rod 21. For improved handling, however, it is quite appropriate to provide the retaining rod 21 with a handle 22 on one side. The handle 22 extends over the retaining rod 21, leaving a clamping slot 23 free. In this way, the orthodontic bracket 10 can be pushed onto the retaining rod 21 until the guide arch 6 is held in the clamping slot 23 between the retaining rod 21 and the handle 22 with a clamping and form-fitting action. In this way, the orthodontic bracket is secured not only to prevent it from falling out but is also held in a certain position.

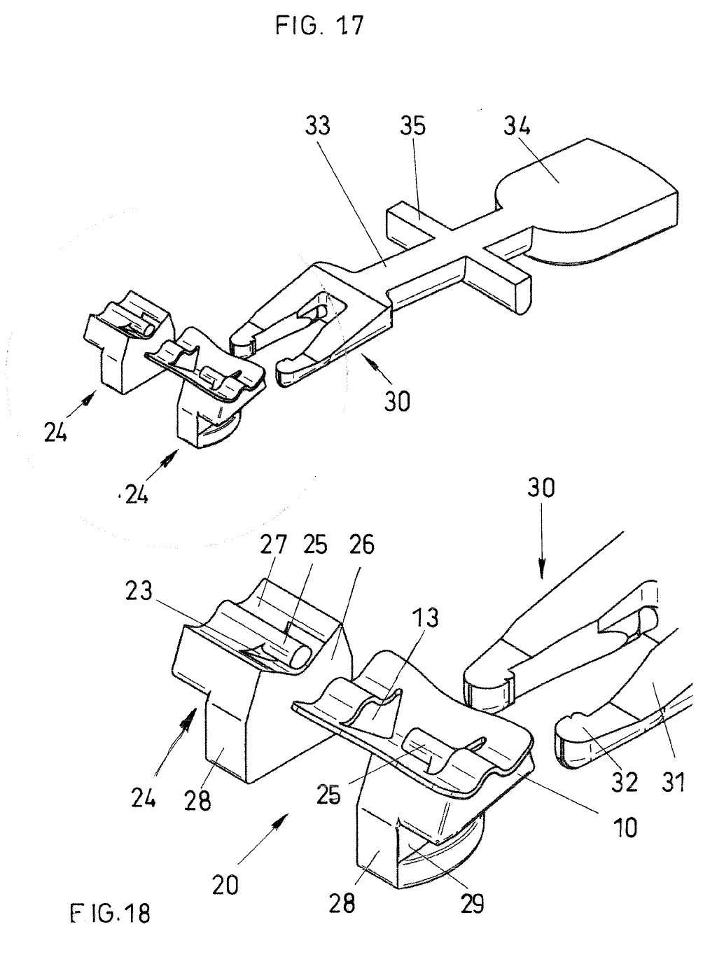

FIGS. 17 and 18 show an alternative protector. This protector 20 is designed in two parts and consists of two molded parts 24 with a retaining rod part 25 integrally molded on each. A clamping slot 23 is shaped in each molded piece 24, which runs so deeply into the respective molded piece that the retaining rod parts 25 are thereby formed. The retaining rod parts 25 are so long that they are at least approximately in contact after being inserted beneath the guide arch 6 at the side. In this way, the side edges of the guide arch are in contact with an end face in the corresponding clamping slots 23 of the two molded pieces 24. At the same time, the flat end faces 26 of the two molded pieces are in approximately surface contact with one another in this position. In the drawings, where FIG. 17 represents the overall situation and FIG. 18 shows an enlarged partial view, one molded piece is already completely pushed onto the orthodontic bracket 1, while the second molded piece is aligned correctly with the orthodontic bracket in a position before the molded piece has been pushed onto the orthodontic bracket. Each molded piece 24 has a shell-shaped recess 27, in which the orthodontic bracket 1 is accommodated in a form-fitting manner, with its visible side lying in form-fitting contact. On the side remote from the shell-shaped recess, one clamping jaw 28 is shaped on each molded piece 24, in which clamping grooves 29 are formed on the side opposite the respective end sides.

The protector 20 comprises as the third part a plier-shaped gripper 30. The gripper 30 has two clamping fingers 31, which are directed at one another, each clamping finger 31 being provided with thickened fingertips 32. These thickened fingertips 32 are located on the clamping jaws 28 on the side opposite the insertion side. The protector 20, comprising the two molded pieces 24, is held securely in the gripper 30 in this way. At the same time, the orthodontic bracket is of course also held securely. Then the adhesive can be applied, and if the adhesive is a light-curing adhesive, it can be cured with a polymerization lamp by shining it laterally into the adhesive spaces 16. Next, the plier-type gripper 30 can be removed and then the molded pieces 24 can be removed with the retaining rod parts 25. The corresponding adhesive then adheres to the molded pieces 28 and/or to the retaining rod parts 25 only extremely lightly, because they are made of a matching plastic, on which the adhesive has hardly any adhesive effect.

During the adhesive bonding, the molded parts and/or the bracket must not only be secured but also must be brought into the correct position on a tooth. In this regard, the actual plier-shaped gripper 30 is equipped with a pointer rod 33. On the end opposite the plier-shaped gripper, a retaining plate 34 is integrally molded on this pointer rod 33. A directional pointer 35 is arranged at a right angle to the pointer rod 33 and crosses the pointer rod 33. The directional indicator 35 shows the treating orthodontic specialist the direction of the guide arch and/or of course also the guide channels, and the orthodontist then knows how to align the bracket with the tooth so that the treatment arch here has the desired shape.

All of the inventive means for positioning the inventive orthodontic bracket 1 are made of plastic.

The orthodontic bracket, which is manufactured by the punching and bending technique, is preferably made of cold-rolled cobalt-chromium-nickel sheet metal, which can be processed especially well because it has only an extremely minor rebound effect after being shaped. Furthermore, this preferred sheet metal material made of CoCrZONi-1-6Mo-7 alloy, which is available on the market under the brand name Phynox®, can be refined to a high hardness by an appropriate heat treatment.

Although the orthodontic brackets according to the invention would be available commercially on the market, in the normal case one would offer the bracket together with the corresponding means for positioning the bracket in a kit, which would then contain both the orthodontic bracket 1 and the protector 20 and optionally the two-part protector consisting of the two molded pieces and the plier-like gripper 30, as described previously.

### REFERENCE LIST

1 base plate
2 visible side
3 adhesive side
4 slot-shaped punched-out area
5 short punched-out areas
6 guide arch
7 aperture
8 lateral plates
9 structured adhesive area
10 orthodontic bracket
11 treatment arch
12 central straps
13 window-shaped punched-out areas
14 guide channels
15 short, ventral or dorsal side edges
16 adhesive spaces
17 longitudinal edges
18 buttonhole-shaped punched-out areas
20 protector
21 retaining rod
22 handle
23 clamping slot
24 molded pieces
25 retaining rod part
26 end faces
27 shell-shaped recess
28 clamping jaw
29 clamping grooves
30 plier-shaped gripper
31 clamping finger
32 fingertips, thickened
33 pointer rod
34 retaining plate
35 direction indicator
LW inside clearance

1. An orthodontic bracket made of sheet metal by punching and bending technique, comprising a base plate with an adhesive side and a visible side and guide means for guided retention of a treatment arch, wherein the bracket is designed in one piece and has at least one elongated guide arch running in the mesial-distal direction, shaped out of the plane of the base plate, as the guide means beneath which the treatment arch can be guided so that it the treatment arch rests on the base plate.

2. The bracket according to claim 1, wherein the base plate has a punched-out area running from mesial to distal directions at the side and two parallel slot-shaped punched-out areas running from the buccal to the gingival direction, between which the guide arch runs from the mesial to the distal direction, and the guide arch is an arch facing away from the tooth on the visible side.

3. The bracket according to claim 1, wherein the base plate has two window-shaped punched-out areas and the base plate is shaped downward toward the adhesive side to the lateral guide channels from the punched-out areas to the lateral, mesial and/or distal edges, while the area between the window-shaped punched-out areas to the visible side is shaped toward the guide arch.

4. The bracket according to claim 1, wherein passages are shaped in the base plate outside of the area of the at least one guide arch.

5. The bracket according to claim 1, wherein the bracket is manufactured from a CoCrZONi-1-6Mo7 alloy.

6. The bracket according to claim 1, wherein the guide arch can be shaped by pressure thereon, so that an inside clearance of the guide arch is adapted to the diameter of the treatment arch.

7. An orthodontic system comprising the bracket of claim 1 and a treatment arch having a round, rectangular or oval cross section.

8. A positioner for positioning the orthodontic bracket according to claim 1, wherein before the positioning, a protector comprises a retaining rod, which is adapted to an inside clearance of the guide arch and can be inserted through the guide arch.

9. The positioner according to claim 8, wherein the retaining rod is connected in one piece to a handle, and a clamping slot is shaped between the handle and the retaining rod so that the guide arch is accommodated in the lateral edge in a force-locking and form-fitting manner.

10. The positioner according to claim 8, wherein the protector is in two parts, wherein one part is provided with a retaining rod part and one each is molded on molded pieces, wherein one part of the two-part protector can be inserted with the retaining rod part from one side into the guide arch of the orthodontic bracket, and the two molded pieces, when completely inserted, are in lateral contact with the guide arch and can be gripped by a plier-type gripper clamping the two parts.

11. The positioner according to claim 10, wherein the gripper is provided with a pointer rod on whose end a retaining plate is integrally molded.

12. The positioner according to claim 11, wherein at least one directional pointer intersecting the pointer rod at a right angle is integrally molded on the pointer rod.

13. The positioner according to claim 8, wherein the positioner is made of plastic.
